(19) United States
(12) Patent Application Publication
(10) Pub. No.: US 2009/0150332 A1
(43) Pub. Date: Jun. 11, 2009

(54) VIRTUAL FILE MANAGING SYSTEM AND METHOD FOR BUILDING SYSTEM CONFIGURATION AND ACCESSING FILE THEREOF

(75) Inventors: Yi-Chang Zhuang, Kaohsiung City (TW); Jian-Hong Liu, Kaohsiung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/022,128

(22) Filed: Jan. 29, 2008

(30) Foreign Application Priority Data
Dec. 6, 2007 (TW) 96146572

(51) Int. Cl. G06F 17/30

(52) U.S. Cl. 707/1; 707/E17.001

(57) ABSTRACT

A virtual file managing system including a file request managing unit, an information repository, a file namespace managing unit, and a file access managing unit is provided. The file request managing unit receives a file access request issued by a client, and returns a processing result of the file access request. The information repository stores a data structure of the virtual file managing system. The file namespace managing unit looks up address and path content of the file from the information repository according to the file access request. The file access managing unit performs an operation of accessing a file according to the address and path content of the file.

### CROSS-REFERENCE TO RELATED APPLICATION

This application claims the priority benefit of Taiwan application serial no. 96146572, filed on Dec. 6, 2007. The entirety of the above-mentioned patent application is hereby incorporated by reference herein and made a part of this specification.

### BACKGROUND OF THE INVENTION

1. Field of the Invention

The present invention generally relates to a virtual file managing system and a method for building system configuration and accessing a file thereof.

2. Description of Related Art

Along with the progress of the digital technology, lifestyle of human beings is gradually changed to a digital lifestyle. Thus, in daily life, a mass of important data and information must be stored in a digital manner. With the popularity and vigorous development of the network, digitalized information possessed by people grows exponentially, such that the space of the digital storage device is required to be greatly expanded.

Under the progress of the digital storage technology, the storage capacity of the storage device is getting larger, so many users are used to storing their private digital data on the storage device. However, the expansion of the capacity of the storage device cannot catch up with the growing demands for the storage space. Particularly, the application of multimedia is limited by number of the storage devices accommodated in a single computer equipment, such that the storage capacity of the computer apparatus has a maximum upper limit. Moreover, in addition to the effort spent for the expansion of storage space of the computer apparatus, the expansion of the storage space indirectly brings side-effect concerning the management and usage to the user. That is, the user must manage and assign the position of the former file data again, so as to make full use of the newly expanded storage space, which is inconvenient for the user.

In recent years, the network storage system that expands storage space based on the network attracts much attention. The user can store the file data on the storage devices on the network by means of network browsing and accessing, so as to simplify the expansion of the storage space. Further, the network accessing manner can achieve the infinite expansion of the storage space without the limitation of the maximum number of the storage devices connected to the single computer, and can also achieve a data sharing among a plurality of people and equipments through the network. However, the problem that the original file data must be assigned again due to the increase of the storage space to achieve a better utilization efficiency of space. The problem aggravates with the increase of the number of the network storage devices.

Moreover, the storage spaces of the network storage device are independent, so the user needs to search and access data on each network storage device. Thus, the increase of the network storage devices will bring inconvenience to the user in searching and accessing data. Therefore, it is an important subject how to provide a single data access interface through which the user can access the data on multiple network storage devices through a single data accessing interface more easily.

In order to solve the problems, in U.S. Pat. No. 6,775,679 and U.S. Pat. No. 6,985,914, folders or files of different file servers are linked together to form a larger meta file system that appears to a user to be a single file system. In the two patents, a program code is inserted for linking the folders or the files of two file systems in the original file system design. However, if the user does not have the source code of the file system, the virtual file system cannot be achieved. In addition, the folder linking mentioned in the above two patents must be manually built and maintained by a system administrator or user, which causes burden on using and management.

Moreover, in U.S. Pat. No. 6,931,410 and U.S. Pat. No. 6,947,940, a uniform file namespace is built in a manner of using a referral object and referral object record list. The referral object is a specially designed file system object, recording name of the referral object and accessing index value of the referral object record list. Therefore, when the two patents are implemented, the file server needs to be modified. On the other hand, the referral object and the referral object record set must be set and maintained by the system administrator, which increases the burden on management.

Moreover, in the two patents, a proxy program must be installed on the client computer to perform the related setting operation. The proxy program is used to read the referral object information responded by the file server and to perform the necessary looking-up action on the referral object record list, which causes additional burden on the user. In addition, it is necessary to remount continually through the proxy program on the client computer to access the file on the different servers, which also increases the burden of the system in operation.

### SUMMARY OF THE INVENTION

Accordingly, the present invention is directed to a virtual file managing system and a method of building system configuration and accessing a file thereof, which permits the files of one folder to be separately stored on a plurality of storage devices without the limitation of the range of the network storage device, thereby improving the use efficiency of the storage space.

The present invention provides a virtual file managing system, which includes a file request managing unit, an information repository, a file namespace managing unit, and a file access managing unit. The file request managing unit receives a file access request issued by a client, and returns a processing result of the file access request. The information repository stores a data structure of the virtual file managing system. The file namespace managing unit looks up address and path content of the file from the information repository according to the file access request. The file access managing unit performs an operation of accessing a file according to the address and path content of the file.

The present invention provides a method of building system configuration, applicable to the virtual file managing system. The method of building system configuration includes the following steps. A join request of a file server is received. It is checked to see if the virtual file managing system has a server or not. If a checking result indicates that the virtual file managing system does not have a server, a server list, a top level folder list, and a file namespace list are built. The file server is joined into the virtual file managing system. It is checked to see if the file server has a file data or not. If a checking result indicates that the server has a file data, the file data is joined into the file namespace list.

The present invention provides a method of accessing a file, applicable to the virtual file managing system. The virtual file managing system has a file namespace list. The method of accessing a file includes the following steps. An access request of a file is received. In the file namespace list, it is checked to see if the file exists or not. If the file exists, the position where the file is stored is acquired. It is determined whether the position is located on the file server of the file access request or not. If the position is not located on the file server, a referral response is built and is returned to the client according to the position where the file is stored.

In the present invention, in accordance with the position of each file, a data structure is built and stored in the information repository, thereby integrating the files of the network storage device, which permits the files of one folder to be separately stored on a plurality of storage devices without the limitation of the range of the network storage device. In this manner, unified configuration and management of the storage space can be achieved, thereby improving the use efficiency of the storage space, simplifying the operation of accessing a file, and reducing burden of the file server.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an architectural view of a virtual file managing system having a uniform file namespace according to an embodiment of the present invention.

FIG. 2 is an implementation example of a virtual file managing system having a uniform file namespace according to an embodiment of the present invention.

FIG. 3 is a schematic view of a virtual file managing system according to an embodiment of the present invention.

FIG. 4A is a schematic view of a server list according to an embodiment of the present invention.

FIG. 4B is a schematic view of a top level folder list according to an embodiment of the present invention.

FIG. 4C is a schematic view of a file namespace list according to an embodiment of the present invention.

FIGS. 5A and 5B are flow charts of a method of building system configuration according to the embodiment of the present invention.

FIG. 5C is a detailed flow chart of step S556 of FIG. 5B.

FIG. 6A is a flow chart of a method of accessing a file according to an embodiment of the present invention.

FIG. 6B is a flow chart of a method of accessing a file according to another embodiment of the present invention.

FIG. 7 is a detailed flow chart of step S604 of FIG. 6A.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

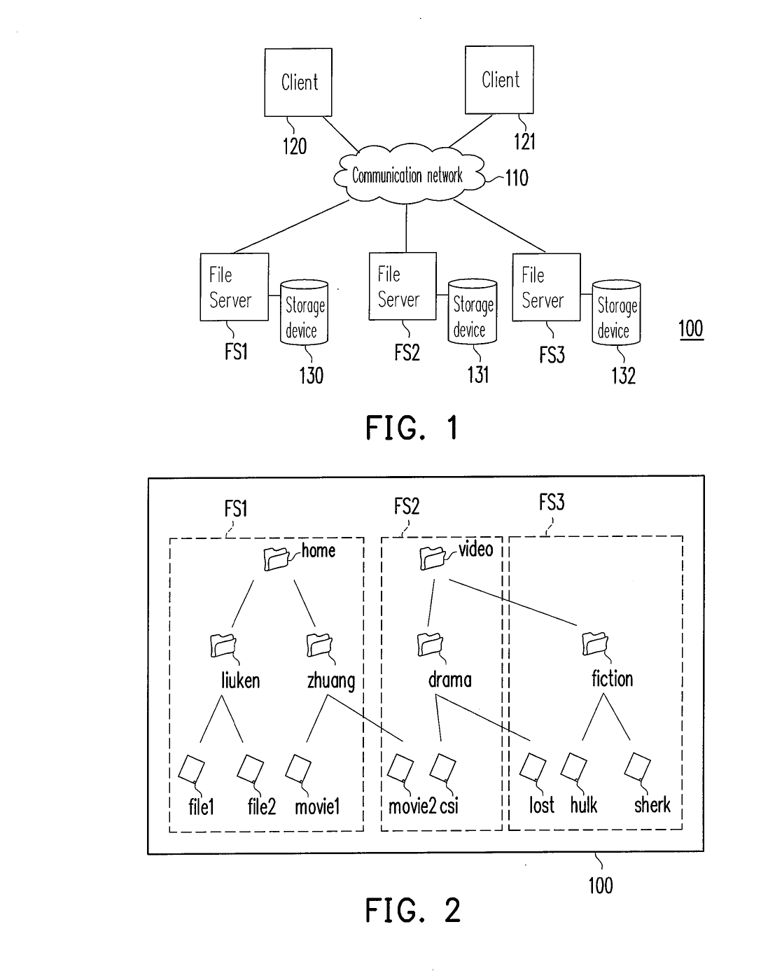

FIG. 1 is an architectural view of a virtual file managing system having a uniform file namespace according to an embodiment of the present invention. Referring to FIG. 1, a virtual file managing system 100 includes a communication network 110, file servers FS1-FS3, clients 120-121, and storage devices 130-132. The storage devices 130-132 are respectively configured on the filer servers FS1-FS3. The communication network 110 may be a wired or wireless network medium. The file servers FS1-FS3 are used to receive and process action requirements issued by the clients 120-121. The storage devices 130-132 are used to store the file data.

In the overall action, after the file servers FS1-FS3 are all connected to the communication network 110, the clients 120-121 can operate and manage the storage devices 130-132 connected to the file servers FS1-FS3 through the communication network 110, so as to access the data stored on the storage devices 130-132.

FIG. 2 is an implementation example of the virtual file managing system 100 having a uniform file namespace according to an embodiment of the present invention. Referring to FIG. 2, the difference between this embodiment and the conventional file server is that the storage space and the folder and file structure provided by the virtual file managing system 100 consists of the folder and file structures of a plurality of physical file servers. Therefore, it can be known from FIG. 2 that the virtual file managing system 100 of this embodiment consists of the file servers FS1-FS3.

Therefore, the clients 120-121 may be connected to the file server FS1, FS2, or FS3 through the communication network 110 to access the top level folders “home” and “video” provided by the virtual file managing system 100. That is, although the folders “home” and “video” are respectively stored in the file servers FS1 and FS2, the folders “home” and “video” seem to be on the same server for the user from the client. In this manner, a transparent effect can be achieved.

Referring to FIG. 2, the folder “home” has folders “liuken” and “zhuang”, and the folder “video” has folders “drama” and “fiction”. In addition, files “file1” and “file2” are both stored in the folder “liuken”, and are located in the storage device of the file server FS1. Although files “movie1” and “movie2” are both stored in the folder “zhuang”, it is different from the folder “liuken” that the files “movie1” and “movie2” are respectively stored in the file server FS1 and the filer server FS2 instead of being stored on the same file server. In addition, the folders “drama” and “fiction” and files “csi” and “lost” have the same situation. That is, a plurality of folders or a plurality of files in the same folder may be respectively stored in different file servers, so as to effectively achieve the storage space allocation function and to reduce an overload of a single file server.

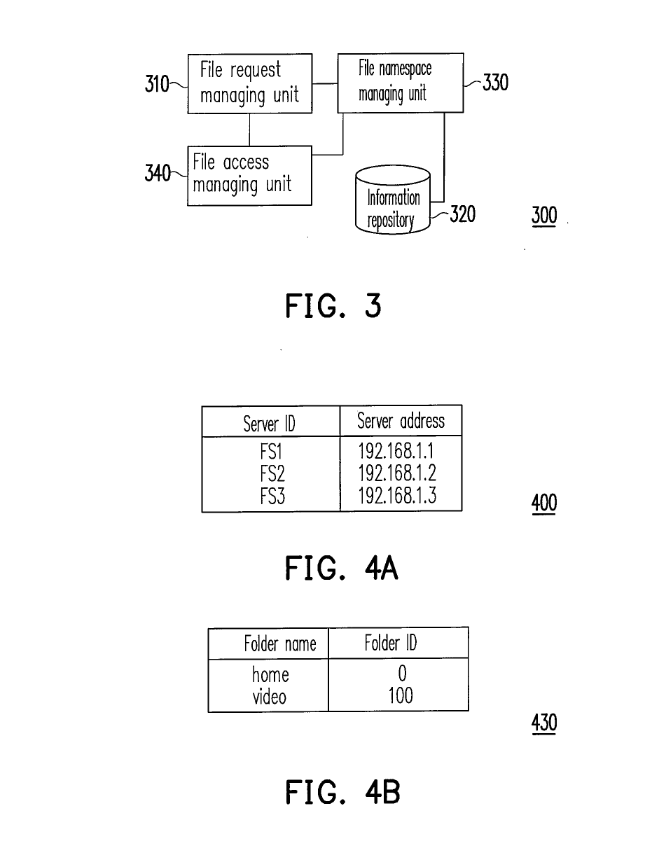

FIG. 3 is a schematic view of a virtual file managing system according to an embodiment of the present invention. Referring to FIG. 3, a virtual file managing system 300 includes a file request managing unit 310, an information repository 320, a file namespace managing unit 330, and a file access managing unit 340. The file request managing unit 310 receives a file access request issued by the client, and returns a processing result of the file access request. The information repository 320 stores a data structure of the virtual file managing system 300. The file namespace managing unit 330 looks up address and path content of the file from the information repository 320 according to the file access request. The file access managing unit 340 performs an operation of accessing a file according to the address and path content of the file.

In the overall action, the file request managing unit 310 receives the file access request issued by the client, and decides whether or not to permit the request according to client rights of the issued request and access rights of the file. If the request does not match the access rights, an error message is generated and returned to the client, so as to inform the user.

If the access rights permit, the request is transmitted to the file namespace managing unit 330, and the file namespace managing unit 330 looks up the address of the server where the file exists and the path content of the file from the information repository 320. Then, the file access managing unit 340 performs the accessing action according the address and path content of the file. Finally, the file request managing unit 310 returns an executing result to the client issuing the request through the communication network.

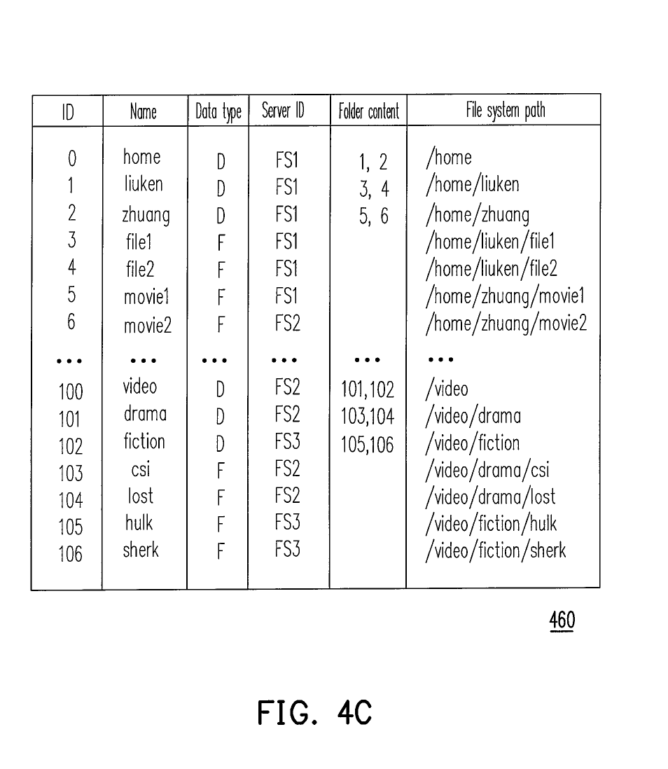

In this embodiment, the data structure stored in the information repository 320 includes a server list 400, a top level folder list 430, and a file namespace list 460, as shown in FIGS. 4A, 4B, and 4C. Referring to FIG. 4A, the server list 400 includes a server ID and a server address, i.e. records the information of the file server in the virtual file managing system 300, i.e. file server FS1 and address 192.168.1.1, file server FS2 and address 192.168.1.2, and file server FS3 and address 192.168.1.3.

Referring to FIG. 4B, the top level folder list 430 includes a folder name and a folder ID, i.e. records the content of the top level folder in the virtual file managing system 300, i.e. the folder “home” and ID 0, and the folder “video” and ID 100.

Referring to FIG. 4C, the file namespace list 460 includes ID, name, data type, server ID, folder content, and file system path, i.e. records the information of all the folders and the files in the virtual file managing system 300. In the file namespace list 460, the symbol D in the data type field indicates that this batch of data is a folder, and the symbol F indicates that this batch of data is a file.

Moreover, the symbol in the folder content field indicates that the folder has other batch of data recorded with reference to the above data ID. For example, 1 and 2 appear in the folder content field of the folder “home”, indicating that the folder “home” still has 2 batches of data, and according to ID 1 and 2, the folders “liuken” and “zhuang” are found, i.e. the folder “home” has the folders “liuken” and “zhuang”.

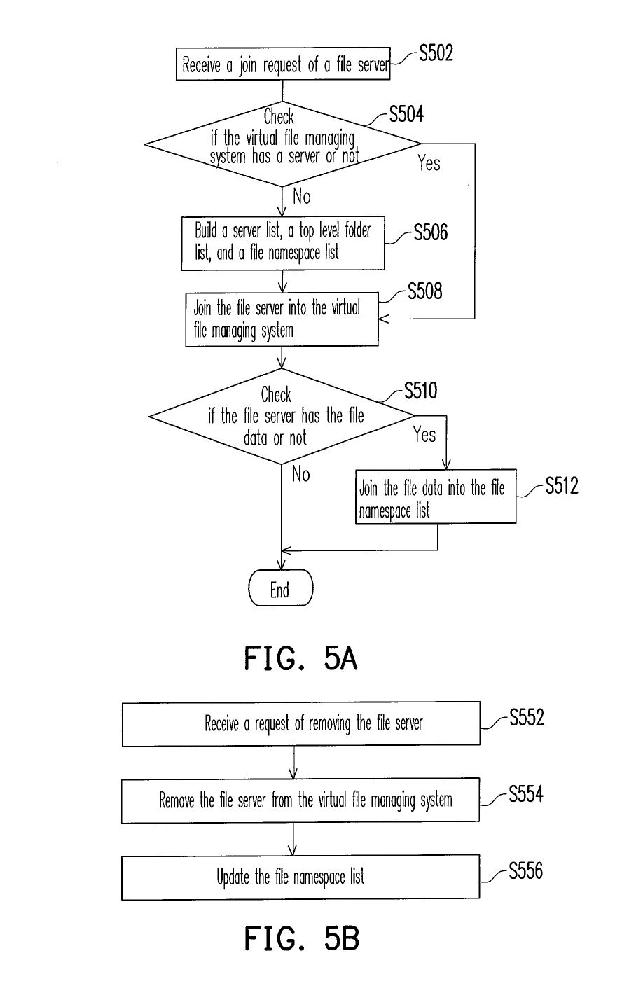

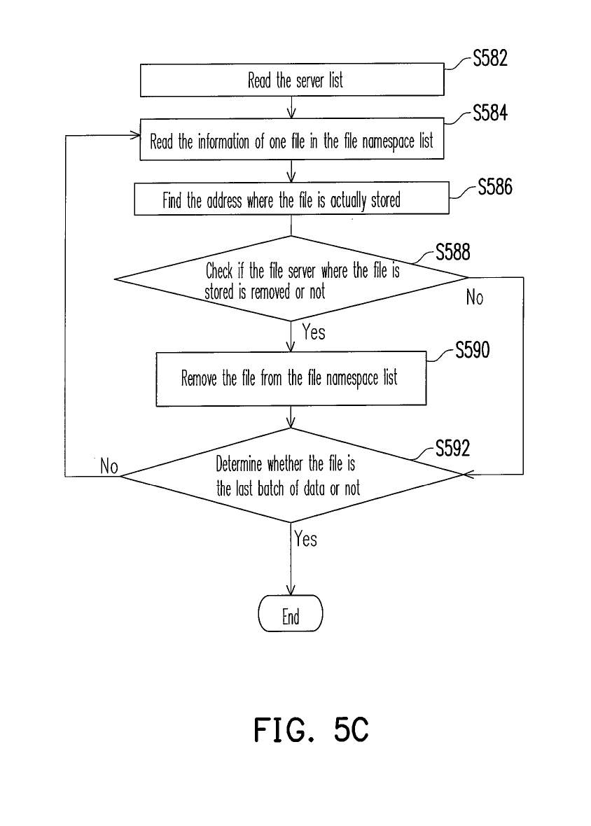

Hereinafter, the procedure of building system configuration of the virtual file managing system 300 is illustrated. FIGS. 5A and 5B are flow charts of the method of building system configuration of the embodiment of the present invention. Referring FIGS. 3 and 5A, firstly, the join request of the file server is received (step S502). For example, the virtual file managing system 300 receives a command request of joining the file server issued by the client.

Then, it is checked to see if the virtual file managing system 300 has the server or not (step S504). If a checking result indicates that the virtual file managing system 300 does not have any server, the joined first server is the first server in the virtual file managing system 300, and the server list, the top level folder list, and the file namespace list are built (step S506), as shown in FIGS. 4A to 4C. After the lists are built and stored in the information repository 320, the file server is joined in the virtual file managing system 300 (step S508).

If a checking result indicates that the virtual file managing system 300 has the server, the procedure directly enters step S508 to add the file server into the virtual file managing system 300. Next, it is checked to see if the joined file server has the file data or not (step S510). If a checking result indicates that the server has the file data, the file data is joined into the file namespace list (step S512). On the contrary, if a checking result indicates that the server does not have the file data, after the new file server information is directly joined into the system configuration, the action of adding the file server is completed.

Referring to FIG. 5B, the virtual file managing system 300 receives a request of removing the file server (step S552), for example, a command request of removing the file server FS3 issued by the client.

Next, in step S554, the file server FS3 is removed from the virtual file managing system 300. Then, the file namespace list is updated (step S556), thus completing the overall action of removing the file server. In addition to removing the file server FS3, the file stored in the file server FS3 must be removed from the file namespace list, so as to help the user avoid performing wrong operation when entering the virtual file managing system 300 and seeing the file of the file server FS3.

Then, the procedure of updating the file namespace list is further illustrated. FIG. 5C is a detailed flow chart of step S556 of FIG. 5B. Referring to FIG. 5C, firstly, the server list is read (step S582). For example, it is assumed that the request issued by the client is the action of removing the file server FS3. At this time, the virtual file managing system 300 reads the server list 400 (FIG. 4A) from the information repository 320, so as to reorganize the system file namespace.

After that, in the file namespace list, the information of the file is read (step S584). In this embodiment, the information of the file is read through checking the content and path of each file in sequence, and only the information of one file is read at a time, and an actual address of the file is found (step S586).

For example, for the file “movie1”, the actual address of the file “movie1” is: the file server FS1, the server address is 192.168.1.1, and the storage path is /home/zhuang/movie1.

Then, it is checked to see if the file server where the file is stored is removed or not (step S588). If a checking result indicates that the file server is already removed, the file is removed from the file namespace list (step S590). For example, when the folder “fiction” with ID 102 in FIG. 4C is read, it is found that the folder “fiction” is originally stored in the file managing system FS3, so the folder “fiction” must be removed from the file namespace list. Then, the virtual file managing system 300 may determine if the deleted file is the last batch of data in the file namespace (step S592). However, if the folder “fiction” is not the last batch of data in the file namespace list 460, the procedure returns to step S584 to perform the action of updating the file namespace till the file is the last batch of data. For example, the virtual file managing system 300 proceeds to perform the action of looking up the file, i.e. to check if the file namespace list 460 has the record of the file and folder stored in the file server FS3 or not. Then, in IDs 105 and 106, the files “hulk” and “sherk” are found to be stored in the file server FS3, the files “hulk” and “sherk” must be removed.

Moreover, after step S586, if a checking result indicates that the file server is not removed, the procedure directly enters step S592 to determine if the file is the last batch of data in the file namespace list or not. Thus, the action of updating the file namespace list 460 is completed.

For example, if the file “movie1” with ID 5 in FIG. 4C is read and the file is stored in the file server FS1 that is not removed, the file “movie1” will not be removed. The file “movie1” is not the last batch of data in the file namespace, so the action of updating the file namespace is still performed till the file is read to be the last batch of data.

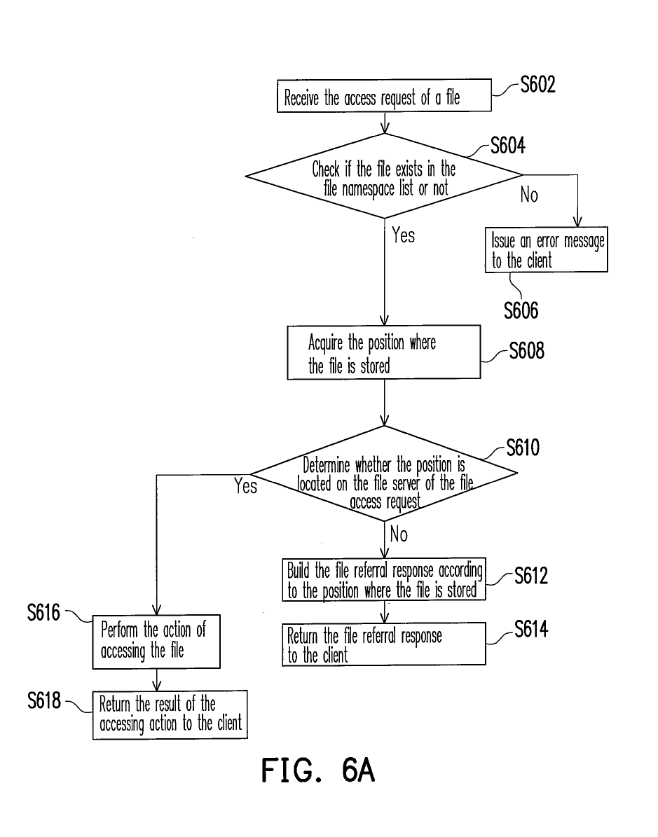

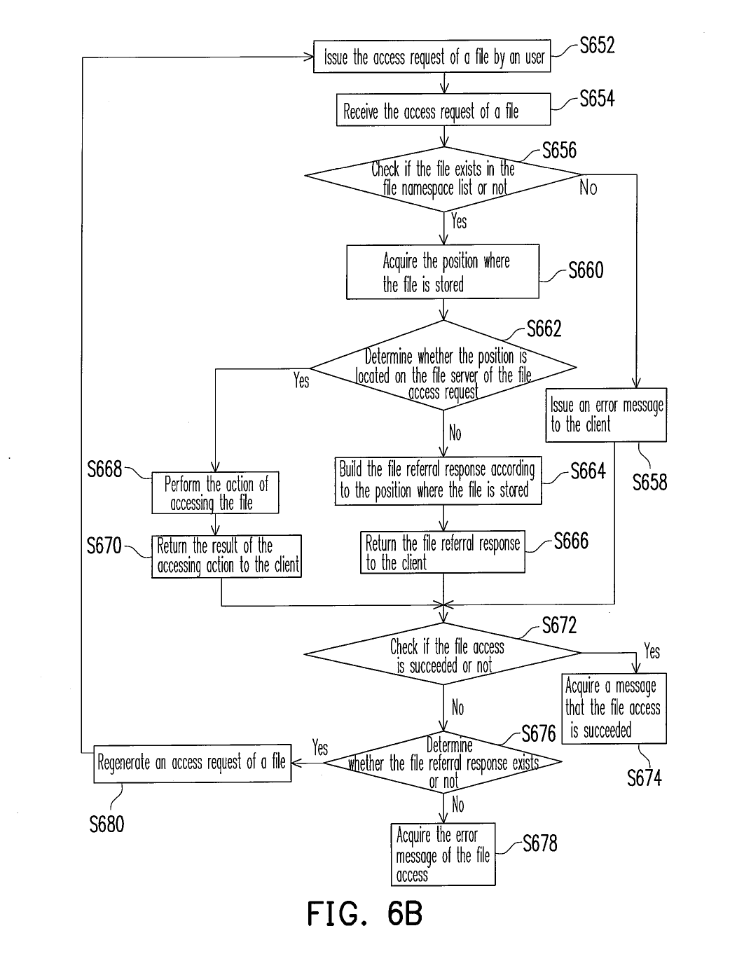

FIG. 6A is a flow chart of a method of accessing a file according to an embodiment of the present invention. This embodiment is applicable to the virtual file managing system 300. Referring to FIG. 6A, firstly, the access request of a file is received (step S602). For example, the virtual file managing system 300 receives the file access request from the client through the network.

Next, in the file namespace list, it is checked to see if the file exists or not (step S604). For example, the content in the information repository 320 is looked up with the file path. If the file does not exist, an error message is issued to the client (step S606), so as to inform the user that the file access request is error, and the virtual file managing system 300 does not have the file.

Moreover, if the file exists, the position where the file is stored is acquired (step S608). For example, the information about the actual position of the file is acquired from the information repository 320. Next, it is determined whether the position is located on the file server of the file access request or not (step S610). That is, it is assumed that when the user is connected to the virtual file managing system 300 through the file server FS1, and the accessed file is also located on the file server FS1, it indicates that the position of the file is located on the file server of the file access request. If the position of the file is located on the file server FS2, it indicates that the position of the file is not located on the file server of the file access request.

Accordingly, if it is found that the position is not located on the file server of the file access request, according to position where the file is stored, the referral response is built (step S612), and the referral response is returned to the client (step S614). That is, when the accessed file, for example the file “movie2”, is located on the file server FS2, the file system path stored in the file namespace list 460 is built as the referral response to be returned to the client, such that the user may know that the file is not in the file server FS1.

Moreover, if it is found that the position is located on the file server of the file access request, as described in step S616, the action of accessing the file is performed, and the result of the accessing action is returned to the client (step S618), so as to inform the user that the accessing of the file is succeeded.

In the above embodiment, the procedure of receiving the access request of the file issued by the client is illustrated. Hereinafter, another embodiment is given to illustrate the procedure of issuing the file access request by the client. FIG. 6B is a flow chart of a method of accessing a file according to another embodiment of the present invention. Referring to FIG. 6B, firstly, in step S652, the user can issue the access request of a file from the client. Then, steps S654-S670 are carried out to perform the action of accessing the file, and steps S645-S670 are the same as or similar to steps S602-S618 of FIG. 6A, so the details will not be described herein again. Next, in step S672, i.e. after the client receives the result of one of steps S658, S666, and S670, it is checked to see if the file access is succeeded or not. If the checking result is yes i.e. the client receives the executing result of step S670, the client may acquire a message that the file access is succeeded in step S674.

In other words, if the checking result is “no”, i.e. the executing result received by the client is the executing result of steps S658 and S666, it is determined whether the referral response exists or not in step S676. That is, the client determines the executing result of steps S658 and S666. If the determining result is “no”, i.e. the client receives the executing result of the step S658, the client may acquire the error message of the file access in step S678.

In other words, if the determining result is “yes”, i.e. the client receives the executing result of step S666, the client may regenerate an access request of a file in step S680. That is, a correct file access request is issued in accordance with the information in the referral response, so as to perform the action of accessing the file.

Then, the procedure returns to step S652, the access request of the file is issued again, so as to achieve the request of correctly accessing the file. For example, it is assumed that the user is connected to the file server FS1 through the communication network, at this time, if the request issued by the client is to perform the accessing action on the file “movie2”, it is found that the file “movie2” is not stored in the storage device of the file server FS1 in step S662. Thus, the virtual file managing system 300 may generate a file “movie2” stored in the file server FS2, and the referral response of the path /home/zhuang/movie of the file “movie2” to the client, so as to inform the user to reissue the request of accessing the file “movie2”, and get connection to the file server FS2 to perform the accessing action on the file “movie2”.

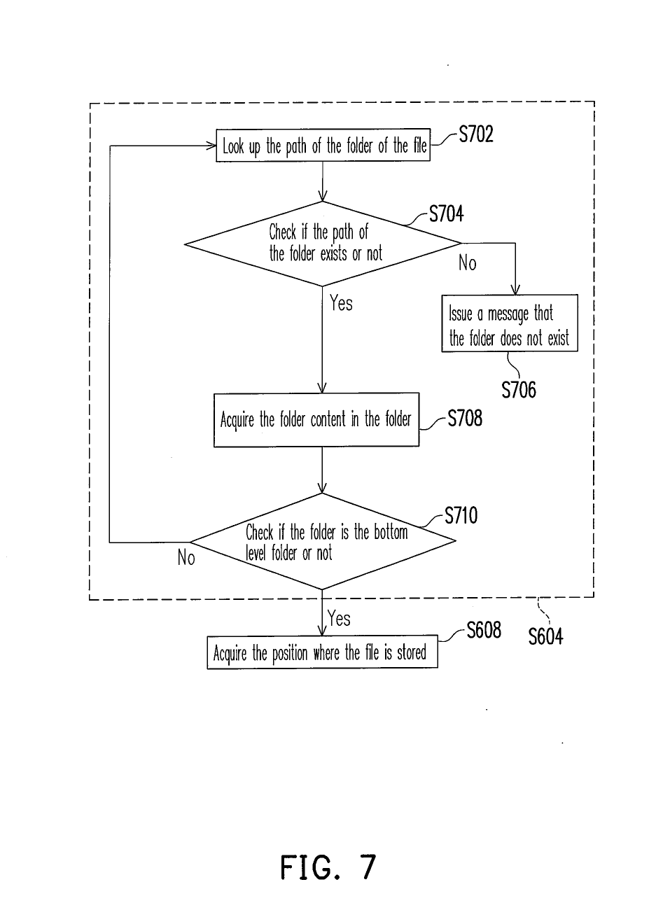

Next, the procedure of checking if the file exists in the file namespace list 460 or not is further illustrated. FIG. 7 is a detailed flow chart of step S604 of FIG. 6A. Referring to FIG. 7, firstly, the path of the folder of the file is looked up (step S702). For example, the virtual file managing system 300 may look up from the information repository 320 through the file namespace managing unit 330, i.e. to look up the storage path and address of the file from the file namespace list 460.

Next, it is checked to see if the path of the folder exists or not (step S704), for example, to confirm the path of the file so as to know if the file exists in the file namespace list 460 or not. If a checking result indicates that the path of the folder does not exist, a message that the folder does not exist is issued (step S706), which indicates that the file of the file access request does not exist.

In addition, if a checking result indicates that the path of the folder exists, the folder content in the folder is extracted (step S708). Next, it is checked to see if the folder is the bottom level folder or not (step S710). If a checking result indicates that the folder is the bottom level folder, the procedure enters step S608 of FIG. 6A to acquire the position where the file is stored.

If a checking result indicates that the folder is not the bottom level folder, the procedure returns to step S702 to perform the looking-up action.

For example, the looking-up manner in this embodiment is the hierarchical look up, i.e. when the file access request issued by the client is to access the file “movie1”, the virtual file managing system 300 firstly looks up the path of the folder of the file “movie1”, i.e. /home/zhuang/movie1. The virtual file managing system 300 firstly confirm if the folder “home” exists or not. If yes, the content of the folder “home” is acquired, i.e. folder “zhuang”. Next, it is determined if the folder “home” is the bottom level folder or not. When the folder “home” is not the bottom level folder, the looking-up action is performed on the folder “zhuang” till the file “movie1” is found, which indicates that the file “movie1” of the file access request issued by the client indeed exists.

To sum up, the present invention uses a data structure consisting of the server list, the top level folder list, and the file namespace list is built to perform the unified configuration and management of the storage space, thereby improving the use efficiency of the storage space effectively. In addition, the present invention allows the user to access data on a plurality of network storage devices through a single accessing interface, thus simplifying the user's operation of accessing the file. Moreover, the present invention can directly expand the storage space and disperse the load of file accessing on a plurality of different servers to avoid overload of a single file server under the condition of not powering off the equipment, so as to effectively relieve the burden of managing the file server.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A virtual file managing system, comprising:
a file request managing unit, for receiving a file access request issued by a client, and returning a processing result of the file access request;
an information repository, for storing a data structure of the virtual file managing system;
a file namespace managing unit, for looking up address and path content of the file from the information repository according to the file access request; and
a file access managing unit, for performing an operation of accessing a file according to the address and path content of the file.

2. The virtual file managing system according to claim 1, wherein the data structure comprises a server list, a top level folder list, and a file namespace list.

3. The virtual file managing system according to claim 2, wherein the file server list comprises a server ID and a server address.

4. The virtual file managing system according to claim 2, wherein the top level folder list comprises a folder name, and a folder ID.

5. The virtual file managing system according to claim 2, wherein the file namespace list comprises an ID, a name, a data type, a server ID, a folder content, and a file system path.

6. A method for building system configuration, applicable to a virtual file managing system, comprising:
receiving a join request of a file server;
checking if the virtual file managing system has a server or not;
if a checking result indicates that the virtual file managing system does not have a server, building a server list, a top level folder list, and a file namespace list;
joining the file server into the virtual file managing system;
checking if the file server has a file data or not; and
if a checking result indicates that the server has the file data, joining the file data into the file namespace list.

7. The method for building system configuration according to claim 6, wherein the server list comprises a server ID and a server address, the top level folder list comprises a folder name and a folder ID, the file namespace list comprises an ID, a name, a data type, a server ID, a folder content, and a file system path.

8. The method for building system configuration according to claim 6, further comprising:
receiving a request of removing the file server;
removing the file server from the virtual file managing system; and
updating the file namespace list.

9. The method for building system configuration according to claim 8, wherein the step of updating the file namespace list comprises:
reading the server list;
reading information about a file in the file namespace list;
finding an address where the file is actually stored;
checking if the file server where the file is stored is removed or not;
if a checking result indicates that the file server is already removed, removing the file from the file namespace list;
determining whether the file is last batch of data of the file namespace list or not;
if a determining result indicates that the file is not the last data, returning to the step of reading information about a file in the file namespace list till finishing update of the file namespace.

10. A method for accessing a file, applicable to a virtual file managing system and having a file namespace list, comprising:
receiving an access request of a file;
checking if the file exists in the file namespace list or not;
if the file exists, acquiring a position where the file is stored;
determining whether the position is located on a file server of the file access request or not;
if the position is not located on the file server, building a referral response and returning the referral response to the client according to the position of the file.

11. The method for accessing a file according to claim 10, wherein the step of checking if the file exists or not further comprises:
if the file does not exist, issuing an error message to the client.

12. The method for accessing a file according to claim 10, wherein the step of determining whether the position is located on the file server of the file access request or not further comprises:
if the position is located on the file server, performing an accessing action on the file and returning a result of the accessing action to the client.

13. The method for accessing a file according to claim 11, further comprising:
issuing the file access request by a client.

14. The method for accessing a file according to claim 13, after the step of returning the referral response to the client, further comprising:
regenerating a file access request, and returning to the step of issuing the file access request by the client.

15. The method for accessing a file according to claim 10, wherein in the file namespace list, the step of checking if the file exists or not further comprises:
looking up a path of the folder of the file;
checking if the path of the folder exists or not; and
if a checking result indicates that the path of the folder exists, acquiring a folder content in the folder.

16. The method for accessing a file according to claim 15, wherein the step of checking if the path of the folder exists or not further comprises:
if a checking result indicates that the path of the folder does not exist, issuing a message that the folder does not exist.

17. The method for accessing a file according to claim 15, wherein the step of acquiring the folder content in the folder comprises:
checking if the folder is the bottom level folder or not;
if a checking result indicates that the folder is the bottom level folder, entering the step of acquiring the position where the file is stored; and
if a checking result indicates that the folder is not the bottom level folder, returning to the step of looking up the path of the folder of the file.
